(19) United States
(12) Patent Application Publication
(10) Pub. No.: US 2004/0180208 A1
(43) Pub. Date: Sep. 16, 2004

(54) Reversibly crosslinked resin compositions and methods

(76) Inventors: Michael A. Bailey, Aston, PA (US); C. Richard Costin, West Chester, PA (US); Gary Ceska, Exton, PA (US)

Correspondence Address: COZEN O'CONNOR, P.C., 1900 MARKET STREET, PHILADELPHIA, PA, 19103-3508, US

(21) Appl. No.: 10/799,515

(22) Filed: Mar. 12, 2004

Related U.S. Application Data
(60) Provisional application No. 60/454,396, filed on Mar. 13, 2003.

(51) Int. Cl. B32B 27/38

(52) U.S. Cl. 428/417

(57) ABSTRACT

A resin composition which exhibits reversible crosslinking behavior prepared by copolymerizing an alpha, beta ethylenically unsaturated monomer with an oil soluble metal salt prepared by reacting (A) a metal compound with (B) an acid functional compound which is a reaction product of (1) an alpha-beta ethylenically unsaturated hydroxy compound and (2) a carboxylic polyacid, anhydride, sulfur oxide, or phosphorus oxide. The process of heating the resin so as to cause reversible crosslinking is also disclosed.

### CROSS-REFERENCE TO RELATED APPLICATIONS

Benefit of Provisional Application Serial No. 60/454,396 filed Mar. 13, 2003 is claimed.

### BACKGROUND OF THE INVENTION

This invention relates to resins, including adhesives, sealants, and putties, and especially to pressure sensitive adhesives, high solids solvent recoverable adhesives, hot melt adhesives, and anaerobic adhesives.

Matsuda et al, U.S. Pat. No. 3,689,427, disclosed paints, molding materials, and adhesives prepared by polymerizing a bivalent metal salt prepared by polymerizing a metal salt prepared by reacting a metal oxide with a carboxyl functional ethylene glycolmethacrylate phthalate, and then polymerizing the metal salt or copolymerizing the metal salt with a copolymerizable ethylenically unsaturated monomer. The resulting polymers are heat resistant, have high tenacity, shock resistance, and adhesive properties.

Fan et al, U.S. Pat. No. 6,380,278, disclosed reacting metal salt polyols which were prepared by reacting metal oxide with a half ester containing a hydroxyl group and a carboxylic acid group with polyisocyantates and hydroxy functional acrylates or methacrylates ot form urethane (meth)acrylate metal salts which are useful in coatings and adhesives. Fan et al disclosed the urethanes to have good adhesion properties, thermal properties, high strength, and reversible ionic crosslinking.

Ceska et al, U.S. Pat. No. 6,399,672 disclosed radiation cured coatings, adhesives, inks, and photoresist compositions prepared from compositions comprising oil soluble metal salts prepared by reacting a metal compound with an acid functional compound which is a reaction product of a hydroxy compound and a carboxylic polyacid, anhydride, sulfur oxide, or phosphorus oxide. The radiation curable compositions comprise a photoinitiator.

Wang et al, U.S. Pat. No. 6,232,366, disclosed pressure sensitive adhesives which have thermo-reversible properties, prepared from water soluble salt, hydrophilic plasticizer, an acidic comonomer, and a (meth)acrylate ester monomer having C₄-C₂₀ alkyl chains.

Acrylic adhesive polymers have been widely used as base resins for pressure sensitive tapes, labels, and other decorative and functional pressure sensitive products. The major benefits of acrylic adhesive polymers are adhesion to a broad range of substrates and excellent durability on exposure to moisture, heat and ultra-violet light. They can be prepared as organic solutions, aqueous emulsions, suspensions or 100% solids that exhibit either thermoplastic or thermosetting crosslinkable behavior. Solution and hot melt acrylic adhesives are typically low molecular weight due to solution and melt viscosity limitations that result in low shear strengths. Accepted practice to compensate for low M_{w} is to crosslink the polymer during the drying process. Typically, these thermoset acrylic resins contain an acrylic monomer with a reactive pendant group such as an amide, carboxyl, hydroxyl or epoxy that can be post-crosslinked with other resins at elevated temperatures. Carboxyl containing polymers can be crosslinked by the use multifunctional metals such as metal alkoxides or acetylacetonates.

It is therefore an object of the present invention to provide a resin composition, which exhibits reversible crosslinking behavior

### SUMMARY OF THE INVENTION

According to the present invention, oil soluble metal salts prepared by reacting (A) a metal compound with (B) an acid functional compound which is a reaction product of (1) an alpha-beta ethylenically unsaturated hydroxy compound and (2) a carboxylic polyacid, anhydride, sulfur oxide, or phosphorus oxide. Preferably the resulant ethylenically unsaturated oil soluble metal salt is copolymerized in the presence of a free radical intitiator with other ethylenically alpha-beta unsaturated compounds to form reversibly crosslinked resins. Preferred uses of these resins are for pressure sensitive adhesives (PSAs) and sealants since PSAs and sealants benefit from the reverse crosslinking phenomenon. The resin composition of the invention is preferably in the form of a hot melt adhesive (HM Adhesive, or HMA) or in the form of a pressure sensitive adhesive (PSA), more preferably a solvent-based PSA or finally in the form of a sealant. PSA may also be a HM PSA.

### DETAILED DESCRIPTION

The resins are cured under conditions other than radiation. The resultant resins exhibit thermoset (crosslinked) behavior at low temperatures but thermoplastic behavior at elevated temperatures due to breaking of the ionic crosslinks that are formed. This phenomenon is very useful in allowing unused resin to be recycled.

Suitable metals include lithium, sodium, potassium, cesium, magnesium, calcium, strontium, barium, titanium, zirconium, vanadium, chromium, molybdenum, tungsten, manganese, iron, cobalt, nickel, palladium, copper, zinc, cadmium, mercury, boron, aluminum, gallium, indium, silicon, germanium, tin, lead, antimony, bismuth, and the like. The metal compound can be, for example, the oxide, halide, alkoxide, hydroxide, nitrate, sulfate, carboxylate, and carbonate. The most preferred metal compound is zinc oxide since it reacts very easily and is readily available.

Suitable anhydrides and dicarboxylic acids include phthalic acid, trimellitic anhydride (which contains one anhydride and one carboxyl group), pyromellitic anhydride, 5-norbornene-endo-2,3-dicarboxylic anhydride, naphthyl anhydride, naphthalene tetracarboxylic acid dianhydride, maleic anhydride, succinic anhydride, chlorendic anhydride, maleic acid, succinic acid, fumaric acid, oxalic acid, malonic acid, glutaric acid, adipic acid, dimer fatty acids, and styrene/maleic anhydride polymers.

The alpha-beta ethylenically unsaturated hydroxy compound is preferably selected among alpha-beta ethylenically unsaturated hydroxy derivatives of polyols, more preferably of diols. More preferably these ethylenically unsaturated derivatives of polyols are partial esters of of these polyols, more preferably of diols, with an alpha-beta ethylenically unsaturated carboxylic acid such as (meth)acrylic acid. Suitable polyols for these ethylenically unsaturated hydroxy derivatives, include diols such as ethylene glycol, propylene glycol, 1,3-propanediol, 1,2, 1,3 or 1,4 butanediols, 2-methyl-1,3-propane diol (MPDiol), neopentyl glycol (NPG), alkoxylated derivatives of such diols, polyether diols, polyester diols, and the like. A preferred diol is polyethylene glycol of the formula HO(C₂H₅O)ₙH wherein n is 2 to about 10.

Suitable higher functional polyols are trimethylol propane (TMP), PETA, di-TMP, di-PETA, glycerol, alkoxylated derivatives thereof, and the like.

An especially preferred metal salt is a zinc salt prepared by reacting methyl hexahydrophthalic anhydride with a polyethylene glycol of the formula HO(C₂H₅O)ₙH wherein n is 6 to form a half ester, and reacting the half ester with zinc oxide. The resultant oil soluble zinc has the structural formula (I) as follows.

The oil soluble metal salt monomers are useful in the preparation of acrylic PSAs and hot melt pressure sensitive adhesive (HMPSA) resins by either bulk, solution or emulsion

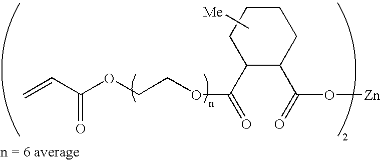

polymerization. The polymerization reaction can proceed at room temperature or higher by adding a free radical polymerization catalyst or merely elevating the temperature. The ratio of the metal salt to copolymerizable monomer can be about 1:1 to 1:20 by weight.

The copolymerizable monomers are selected depending on the application. Preferably they are selected from one or more (meth)acrylates and more preferably for PSA's is selected from a mixture of butyl acrylate and 2-ethyl hexyl acrylate. For PSAs, it is highly preferred to use 2-ethylhexyl acrylate and acrylic acid as comonomers with the oil soluble metal salt. For sealants, butyl acrylate and methyl methacrylate copolymerizable monomers can be used.

The resultant acrylic copolymers of oil soluble metal salts exhibit higher glass transition temperatures (Tg's) and increased modulus or stiffness compared to conventional acrylic adhesive polymers, while maintaining sufficient tack to perform as a pressure sensitive material. More importantly, adhesive resins prepared with these unique ionic crosslinkers still exhibit thermoplastic behavior or flow when heated to allow for ease of application. This phenomena is demonstrated by thermal analysis technique and peel and shear adhesion testing.

A second aspect of the invention is a process for recovering a crosslinked resin obtainable according to the present invention as defined above, for recycling the said resin, comprising the steps of: i) copolymerizing a composition as defined according to the present invention as defined above, to form an ionically crosslinked resin, and ii) recovering the said resin by heating the ionically crosslinked resin to a temperature wherein the resin flows.

The temperature at step ii) is at least the temperature at which the resin is extrudable.

### EXAMPLES

The following examples illustrate a few embodiments of the invention. All parts and percentages are by weight unless otherwise indicated.

### Examples 1 to 6

### Solvent-Based PSA's

Solvent-based PSA's formulations were prepared comparing acrylic polymers made by bulk polymerization with no crosslinker, a typical covalent crosslinker like SR-350 and an ionic crosslinking monomer organic soluble zinc salt. 0% and 2% crosslinker by weight was added to BA-MMA and 2-EHA/Acrylic Acid copolymers respectively and thermal analysis was performed. Samples with no crosslinker behave like a PSA exhibiting two Tg's. The samples were then dissolved at 25% by weight in Ethyl Acetate for making drawdowns for PSA testing. The covalent samples Examples 5 and 6) did not dissolve. The ionic samples did go into solution after 24 hours on a paint shaker. The results are reported in Table 1 below. Comparative examples are indicated by *.

TABLE 1
Results for Solvent-Based Acrylic
PSA's with Reversible Crosslinking

| Example | | | | | |
|---|---|---|---|---|---|
| 1* | 2 | 3* | 4 | 5* | 6* |

| | | | | | | |
|---|---|---|---|---|---|---|
| Butyl Acrylate¹ | 80 | 78 | | | 78 | |
| Methyl Methacrylate¹ | 20 | 20 | | | 20 | |
| 2-Ethylhexyl Acrylate¹ | | | 95 | 93 | | 93 |
| Acrylic Acid¹ | | | 5 | 5 | | 5 |
| PRO-5474 Soluble Zinc² | | 2 | | 2 | | |
| Salt | | | | | | |
| SR-350 TMPTMA² | | | | | 2 | 2 |
| Vazo 67 Azonitrile³ | | | | | | |
| ASTM D Probe Tack | 3.01 | 3.53 | 4.71 | 3.81 | — | — |
| N (lbf) | (0.677) | (0.795) | (1.06) | (0.856) | | |
| ASTM D903 Peel | | | | | | |
| Strength | | | | | | |
| N/m(lbs/inch) | | | | | | |
| 24 hrs @ 25° C. | 333(1.9) | 648(3.7) | 263(1.5) | 140(0.8) | NA | NA |
| 30 mins @ 150° C. | 145(1.4) | 350(2.0) | 578(3.3) | 771(4.4) | NA | NA |
| DSC Analysis (−100 to | | | | | | |
| 250° C.) | | | | | | |
| Tg 1 | −49.6 | −17.4 | −67.1 | −35.4 | −32.9 | −18.4 |
| Tg 2 | | 5.2 | | −21.5 | 2.1 | 4.0 |

¹Aldrich
²Sartomer Co.
³Dupont

### Examples 7 to 10

A second set of solvent-based PSA formulations were prepared from polymers made by solution polymerization with and without crosslinker (3.0% by weight) as set forth in Table 2. In this experiment a conventional SR-2000 long chain diol diacrylate monomer was used as covalent crosslinker for comparison to the ionic crosslinkers NTX-5474 organic soluble metallic monomer and NTX-5910 organic soluble metallic urethane oligomer used according to the invention. Thermal analysis was then performed on the resulting copolymers to determine glass transition temperature. Then drawdowns were prepared as in Examples 1-6. Probe tack, peel, and lap shear adhesion results are reported in Table 2. It was again observed that the polymer prepared with 3% covalent crosslinker (Examples 5 and 6) gelled, absorbing solvent but not redisolving and, therefore, no adhesive testing could be conducted.

TABLE 2
Zn Salt in Acrylic Solvent-Based PSA's

| Composition | 7* | 8* | 9 | 10* |
|---|---|---|---|---|
| 2-Ethylhexyl | 85.5 | 82.8 | 82.8 | 82.8 |
| Acrylate¹ | | | | |
| Acrylic Acid¹ | 4.5 | 4.5 | 4.5 | 4.5 |
| NTX-5474 Zn | | 2.7 | | |
| Monomer² | | | | |
| NTX-5910 Zn | | | 2.7 | |
| Oligomer² | | | | |
| SR-2000 C14 | | | | 2.7 |
| Diol | | | | |
| Diacrylate² | | | | |
| Ethyl Acetate¹ | 210 | 210 | 210 | 210 |
| Vazo 67³ | 0.18 | 0.18 | 0.18 | 0.18 |
| Tg's by DSC | | | | |
| Tg 1 | −60.8 | −54.8 | −54.3 | NA |
| Tg 2 | NA | 27.7 | 25.0 | NA |
| Probe Tack, | 3.97(0.892) | 3.67(0.824) | 4.15(0.933) | NA |
| N (lbf) | | | | |
| Peel Strength | | | | |
| N/m (lbf/in) | | | | |
| 30 mins. @ | 1100(6.3) | 580(3.3) | 740(4.2) | NA |
| 25° C.; | | | | |
| 30 mins @ | | | | |
| 80° C. | | | | |
| 30 mins @ | 1030(5.9) | 560(3.2) | 810(4.6) | NA |
| 25° C.; | | | | |
| 30 mins @ | | | | |
| 150° C. | | | | |
| Shear | | | | |
| Stress (mins) | | | | |
| Cured @ | 7.0 | 15.0 | 29.0 | NA |
| 80° C. | | | | |
| Cured @ | 11.0 | 15.0 | 64.0 | NA |
| 150° C. | | | | |
| Lap Shear | 20.0(2.9) | 35.2(5.1) | 29.6(4.3) | NA |
| Adhesion | | | | |
| KPa (psi) | | | | |

¹Aldrich
²Sartomer Co.
³Dupont

### Examples 11 to 13

### Hot Melt Adhesives

Hot melt PSA's were prepared by addition of 80 phr of a hydrocarbon resin (Sunbelt TO-125 YS Resin) to the solvent based copolymers prepared in Examples 1 to 6. The resins were dissolved by heat and agitation on a hot plate. The solvent was then stripped off in a rotoevaporator. The resulting hot melts were then heated on a hotplate to 100° C. and drawn down on 1″×3″ steel coupons for lap shear measurement. The lap shear results for the hot melts are reported in Table 3.

TABLE 3
Zn Salt in Acrylic Hot Melt PSAs

| Experiment | 11* | 12 | 13* |
|---|---|---|---|
| 2-Ethylhexyl Acrylate | 95.0 | 92.0 | 92.0 |
| Acrylic Acid | 5.0 | 5.0 | 5.0 |
| NTX-5474 Zn Monomer | | 3.0 | |
| NTX-5910 Zn Oligomer | | | 3.0 |
| Vazo 67 | 0.16 | 0.16 | 0.16 |
| Sunbelt TO-125YS | 80.0 | 80.0 | 80.0 |
| Lap Shear Adhesion to CRS | 30.3 | 51.7 | 66.2 |
| KPa (psi) | | | |
| 30 mins @ 80° C. | (4.4) | (7.5) | (9.6) |

### Examples 14 to 17

### Solvent-Based PSA from Solution Copolymers Without Acrylic Acid

Solvent-based PSA's were prepared from solution copolymers of Butyl Acrylate and Methyl Methacrylate, with and without ionic crosslinkers. These examples demonstrate higher concentrations of crosslinker in the polymer without gelling. A higher polymerization temperature, higher boiling solvent, and a high temperature initiator were used. Copolymers were prepared with and without the metallic monomer ionic croslinker at 5% by weight in formulations reported in Table 4. The high solids PSA's prepared from the copolymers formulated were tested for Probe Tack and Peel Strength. The results are reported in Table 4.

TABLE 4
BA-Methyl Methacrylate PSA copolymers
with Soluble Metal Salts

| Composition | 14* | 2 | 3 |
|---|---|---|---|
| Butyl Methacrylate | 72 | 67.5 | 67.5 |
| Methyl Methacrylate | 18 | 18 | 18 |
| Zn Monomer of Formula (I) | | 4.5 | |
| Zn Oligomer | | | 4.5 |
| n-Propyl Acetate | 210 | 210 | 210 |
| Luperox 575 Peroxide | 0.60 | 0.60 | 0.60 |
| Initiator | | | |
| Tg's by DSC | — | — | — |
| Probe Tack N (lbf) | 2.26(0.508) | 2.20(0.494) | 2.01(0.452) |
| Peel Strength N/m (lbf/in) | | | |
| 30 mins. @ 25° C.; | 74.4(0.425) | 317.7(1.814) | 394.0(2.250) |
| 30 mins @ 80° C. | | | |
| 30 mins @ 25° C.; | 127(0.726) | 340.4(1.656) | 340.4(1.944) |
| 30 mins @150° C. | | | |
| Shear Stress (mins) | | | |
| Cured @ 80° C. | 8.0 | 28.0 | 21.0 |
| Cured @ 150° C. | 12.0 | 31.0 | 30.0 |

While the invention has been disclosed and exemplified in detail herein, various alternatives, modifications, and improvements should become readily apparent to those skilled in this art without departing from the spirit and scope of the invention.

What is claimed is:

1. A resin composition which exhibits reversible crosslinking behavior prepared by copolymerizing an alpha, beta ethylenically unsaturated monomer with an oil soluble metal salt prepared by reacting (A) a metal compound with (B) an acid functional compound which is a reaction product of (1) an alpha-beta ethylenically unsaturated hydroxy compound and (2) a carboxylic polyacid, anhydride, sulfur oxide, or phosphorus oxide.

2. The resin composition of claim 1 prepared in the presence of a free radical initiator.

3. The resin composition of claim 1 in the form of a hot melt adhesive.

4. The resin composition of claim 1 in the form of a pressure sensitive adhesive or sealant.

5. The resin composition of claim 4 wherein the pressure sensitive adhesive is a solvent based adhesive.

6. The resin composition of claim 1 wherein the alpha, beta ethylenically unsaturated monomer is one or more (meth)acrylates.

7. The resin composition of claim 6 in the form of a pressure sensitive adhesive wherein the unsaturated monomer is a mixture of butyl acrylate and 2-ethyl hexyl acrylate.

8. The composition of claim 1 cured in the absence of radiation conditions.

9. The composition of claim 1 wherein the metal of the metal compound is selected from the group consisting of lithium, sodium, potassium, cesium, magnesium, calcium, strontium, barium, titanium, zirconium, vanadium, chromium, molybdenum, tungsten, manganese, iron, cobalt, nickel, palladium, copper, zinc, cadmium, mercury, boron, aluminum, gallium, indium, silicon, germanium, tin, lead, antimony, and bismuth.

10. The composition of claim 9 wherein the metal salt is zinc oxide.

11. The composition of claim 1 wherein the carboxylic polyacid, anhydride, sulfur oxide, or phosphorus oxide is selected from the group consisting of include phthalic acid, trimellitic anhydride, pyromellitic anhydride, 5-norbornene-endo-2,3-dicarboxylic anhydride, naphthyl anhydride, naphthalene tetracarboxylic acid dianhydride, maleic anhydride, succinic anhydride, chlorendic anhydride, maleic acid, succinic acid, fumaric acid, oxalic acid, malonic acid, glutaric acid, adipic acid, dimer fatty acids, styrene/maleic anhydride polymers, and methyl hexahydrophthalic anhydride.

12. The resin composition of claim 1 wherein the alpha-beta ethylenically unsaturated hydroxyl compound is an ethylenically unsaturated hydroxy derivative of a polyol.

13. The resin composition according to claim 12, wherein the said ethylenically unsaturated hydroxy derivative of polyol is selected from the group consisting of ethylene glycol, propylene glycol, 1,3-propanediol, 1,2, 1,3 or 1,4 butanediols, 2-methyl-1,3-propane diol (MPDiol), neopentyl glycol (NPG), alkoxylated derivatives of such diols, polyether diols, and polyester diols.

14. The resin composition according to claim 1 wherein the said oil soluble metal salt is a zinc salt prepared by reacting methyl hexahydrophthalic anhydride with a polyethylene glycol acrylate of the formula HO(C₂H₅O)ₙ OCHC═CH₂ wherein n is 6 to form a half ester, and reacting the half ester with zinc oxide.

15. A process for recovering a crosslinked resin of claim 1 for recycling the said resin, comprising the steps of:
i) copolymerizing a composition as defined according to claim 1 to form an ionically crosslinked resin, and ii) recovering the said resin by heating the ionically crosslinked resin to a temperature wherein the resin flows.

16. The process of claim 15 wherein the temperature at step ii) is at least the temperature at which the resin is extrudable.

17. A process for recovering crosslinked resin for recycling comprising polymerizing a composition according to claim 1 to form an ionically crosslinked resin, and recovering resin by heating the ionically crosslinked resin to a temperature wherein the resin flows.

18. The process of claim 17 wherein the temperature is at least the temperature at which the resin is extrudable.

19. The process of claim 17 in the form of a pressure sensitive adhesive or sealant.

20. The process of claim 17 wherein the alpha, beta ethylenically unsaturated monomer is one or more (meth)acrylates.

21. The process of claim 17 in the form of a pressure sensitive adhesive wherein the unsaturated monomer is a mixture of butyl acrylate and 2-ethyl hexyl acrylate.

22. The process of claim 17 wherein the metal salt is zinc oxide.

23. The process of claim 17 The process of claim 17 wherein the metal salt is zinc oxide, the hydroxy functional compound is polyethylene glycol having 2 to 10 ethylene units, and the carboxylic polyacid, anhydride, sulfur oxide, or phosphorus oxide is methyl hexahydrophthalic anhydride.

24. The process of claim 23 wherein the comonomer is a mixture of butyl acrylate and 2-ethyl hexyl acrylate.

25. The process of claim 17 wherein the carboxylic polyacid, anhydride, sulfur oxide, or phosphorus oxide is selected from the group consisting of include phthalic acid, trimellitic anhydride, pyromellitic anhydride, 5-norbornene-endo-2,3-dicarboxylic anhydride, naphthyl anhydride, naphthalene tetracarboxylic acid dianhydride, maleic anhydride, succinic anhydride, chlorendic anhydride, maleic acid, succinic acid, fumaric acid, oxalic acid, malonic acid, glutaric acid, adipic acid, dimer fatty acids, and styrene/maleic anhydride polymers.
